(19) United States
(12) Patent Application Publication
(10) Pub. No.: US 2016/0258575 A1
(43) Pub. Date: Sep. 8, 2016

(54) Lighting-On Device and Grip Device Therefor

(71) Applicants: BOE Technology Group Co., Ltd., Beijing (CN); Beijing BOE Display Technology Co., Ltd., Beijing (CN)

(72) Inventors: Xudong Zhang, Beijing (CN); Ting Cai, Beijing (CN); Haibin Liu, Beijing (CN); Zhenshan Lu, Beijing (CN); Peng Wang, Beijing (CN)

(21) Appl. No.: 14/805,043

(22) Filed: Jul. 21, 2015

(30) Foreign Application Priority Data
Mar. 5, 2015 (CN) 201520128665.0

(51) Int. Cl. F16M 13/02; G02F 1/13

(52) U.S. Cl. CPC F16M 13/02; G02F 1/1309

(57) ABSTRACT

At least one embodiment of the present disclosure provides a grip device for a lighting-on device which is used for detecting defects of a display panel. The grip device can grip a display panel by cooperating with a base of a lighting-on machine, so that the inclination angle of the display panel can be 75° to 90° during lighting-on test. Thereby the effective detection of defects can be ensured.

This application claims priority to Chinese Patent Application No. 201520128665.0 filed on Mar. 5, 2015. The present application claims priority to and the benefit of the above-identified application and is incorporated herein in its entirety.

### TECHNICAL FIELD

Embodiments of the present disclosure relate to a lighting-on device and a grip device therefor.

### BACKGROUND

In the manufacturing process of TFT-LCD (Thin Film Transistor Liquid Crystal Display), it is necessary to perform lighting-on test on liquid crystal display panels to detect whether there is a bright spot or a bright line on the liquid crystal display panels.

At present, in the TFT-LCD (thin film transistor liquid crystal display, TFT-LCD) lighting-on testing process, in order to ensure an effective detection of defective products, detection angles of the back light module and the display panel (Open Cell) are both set to be horizontally placed at 75° to 90°. Test angles of a display panel with moderate or small size can be achieved by fixing the test angle of the back light unit (BLU), placing an open cell on the surface of the BLU during the test, and supporting edges of the panel by the model frame of the BLU.

As for an open cell products with very large size, since the panel has a very large size and is very heavy, the flatness of the panel will be influenced if an inclination angle is too large and the panel is inclined to slip off the model frame of BLU due to its own tension which is oriented outwards. The above risk increases as the inclination angle of the panel increases. To avoid the risk, the current test angle of an open cell with a large size can only be in a range of 0° to 45°. The limited test angle causes failures in detecting some defects of product and the product quality is adversely affected.

### SUMMARY

At least one embodiment of the present disclosure provides a lighting-on device and a grip device therefor. The grip device can grip a display panel by cooperating with a base of a lighting-on machine, so that the inclination angle of the display panel can be 75° to 90° during lighting-on test.

At least one embodiment of the present disclosure provides a grip device, comprising a chassis, a lower handle arm, a compressing block, an upper handle arm, a press rod, and a link mechanism, wherein
the lower handle arm is mounted on the chassis and is provided with a guiding groove extending in a direction from a first end to a second end of the lower handle arm; the compressing block can be slidably mounted to the lower handle arm along a direction in which the guiding groove extends, a spring is disposed between the compressing block and the lower handle arm and applies a thrust force to the compressing block with towards a first end of the lower handle arm upon being energized;
one end of the press rod is mounted to a first end of the lower handle arm via a first pivot, and the other end of the press rod is provided with a press head;
one end of the upper handle arm is mounted to the press rod via a second pivot which is positioned between the press head and the first pivot;
one end of the link mechanism is mounted to the upper handle arm via a third pivot, and the other end of the link mechanism is mounted to the compressing block via a fourth pivot, and the angle between the link mechanism and the lower handle arm which is at the side of the first end of the lower handle arm is an acute angle;
the first pivot, the second pivot, the third pivot, and the fourth pivot are parallel with each other, and the first pivot is perpendicular to the direction in which the guiding groove extends.

During a lighting-on test, a display panel under test is placed on the base of the lighting-on machine and the grip device is fixed onto the base via the chassis.

At least one embodiment of the present disclosure further provides a lighting-on machine, comprising the grip device as described above.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative of the disclosure.

FIG. 1 is a schematic structural view of the grip device according to an embodiment of the present disclosure; and

FIG. 2 is a partially schematic structural view of the grip device according to an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

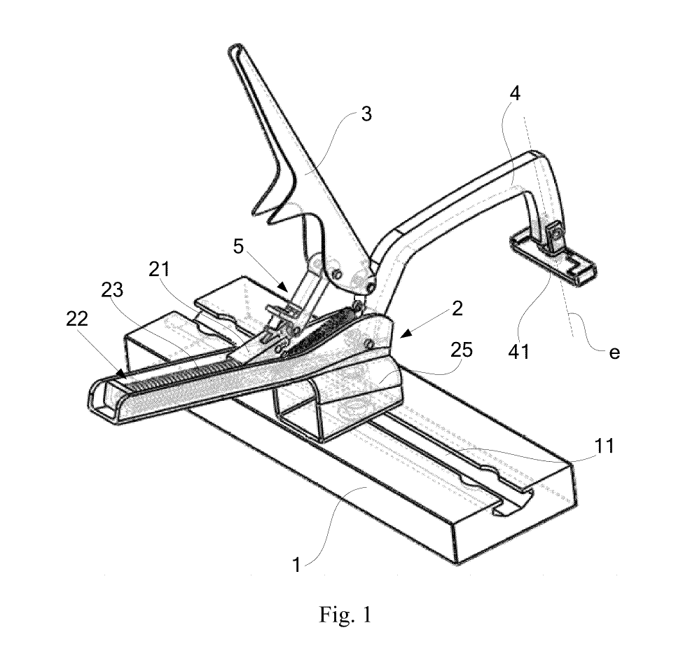

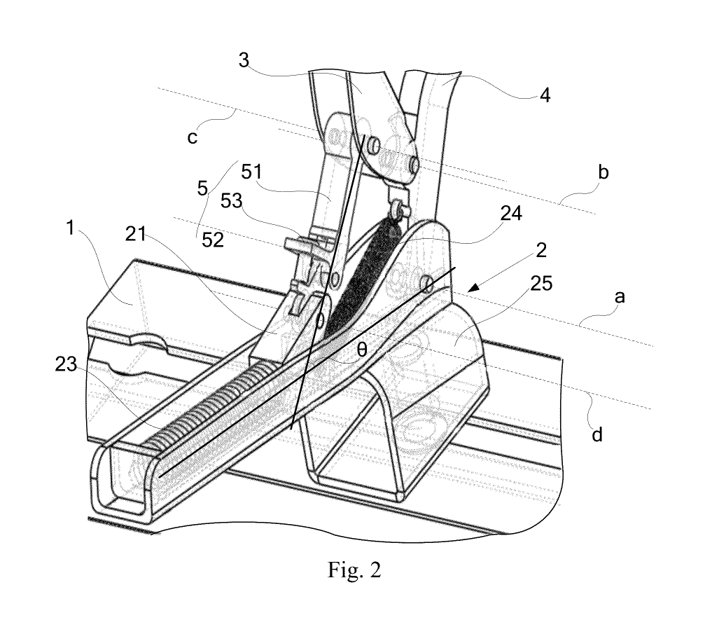

Please refer to FIG. 1 and FIG. 2, wherein FIG. 1 is a schematic structural view of the grip device according to an embodiment of the present disclosure; FIG. 2 is a partially schematic structural view of the grip device according to an embodiment of the present disclosure.

As illustrated in FIG. 1 and FIG. 2, an embodiment of the present disclosure provides a grip device comprising a chassis 1, a lower handle arm 2, a compressing block 21, an upper handle arm 3, a press rod 4, and a link mechanism 5, wherein

One end of the press rod 4 is pivotally connected to a first end of the lower handle arm 2 via a first pivot a, and the other end of the press rod 4 is provided with a press head 41. The press rod 4 can rotate about the first pivot a so that the press head 41 located at the other end moves towards the display panel under test.

One end of the upper handle arm 3 is pivotally connected to the press rod 4 via a second pivot b which is positioned between the press head 41 and the first pivot a.

The lower handle arm 2 is mounted on the chassis 1 and is provided with a guiding groove 22 extending in a direction from a first end to a second end of the lower handle arm 2. The compressing block 21 can be slidably mounted to the lower handle arm 2 along a direction in which the guiding groove 22 extends. A spring 23 is disposed between the compressing block 21 and the lower handle arm 2. When being energized, the spring 23 applies a thrust force to the compressing block 21 towards the first end of the lower handle arm 2.

One end of the link mechanism 5 is connected to the upper handle arm 3 via a third pivot c, and the other end of the link mechanism 5 is connected to the compressing block 21 via a fourth pivot d. The angle θ between the link mechanism 5 and the lower handle arm 2 which is at the side of the first end of the lower handle arm 2 is an acute angle. As illustrated in FIG. 1, when the upper handle arm 3 rotates about the second pivot b with respect to the press rod 4, a pressing force is generated and is applied to the link mechanism 5. The pressing force acts on the compressing block 21 via the link mechanism 5, so that the compressing block 21 slides along the guiding groove 22 in a direction from the first end to the second end of the lower handle arm 2.

The first pivot a, the second pivot b, the third pivot c, and the fourth pivot d are parallel with each other. The first pivot a is perpendicular to the extending direction of the guiding groove 22.

When performing lighting-on test, a display panel under test is placed on a base of the lighting-on machine, and the grip device as described above is fixed onto the base of the lighting-on machine via the chassis 1. In the above-mentioned grip device, when the upper handle arm 3 is pressed to be rotated about the second pivot b with respect to the press rod 4, the upper handle arm 3 applies a thrust force to the press rod 4 so that the press rod 4 rotates about the first pivot a and thus the press head 41 located at the other end of the press rod 4 is moved towards the display panel under test until the press head 41 is pressed onto the display panel. While the upper handle arm 3 being pressed, the upper handle arm 3 applies a pressing force to the link mechanism 5 connected therewith. The pressing force is passed to the compressing block 21 via the link mechanism 5. A direction of the acting force on the compressing block 21 by the link mechanism 5 is directed to the compressing block 21 along the lengthwise direction of the link mechanism 5. Since the angle θ between the link mechanism 5 and the lower handle arm 2 which is at the side of the first end of the lower handle arm 2 is an acute angle, according to stress analysis, the compressing block 21 subject to action of force tends to move towards the second end of the lower handle arm 2 along the guiding groove 22 of the lower handle arm 2 so as to compress the spring 23 with which it is connected.

When the upper handle arm 3 rotates about the second pivot b to meet with the lower handle arm 2, the press head 41 is pressed to a side of the display panel which is opposite to the base and the spring 23 is in a state of being compressed and energized. At this time, the spring 23 which is in an energized state can apply a thrust force to the compressing block 21 towards the first end of the lower handle arm 2. Under effect of the thrust force, the compressing block 21 pushes the link mechanism 5 with which it is connected and which can pass the force to the press rod 4 via the upper handle arm 3 connected with the link mechanism 5. At this time, the force acting on the press rod 4 via the upper handle arm 3 is oriented to the press rod 4 along the upper handle arm 3 and can make the press head 41 located at one end of the press rod 4 keep pressing on the display panel. Since the display panel is positioned between the base and the press head 41 of the grip device, the display panel can be gripped.

The grip device as described above can cooperate with the lighting-on machine to grip the display panel. Therefore, during the lighting-on test, the inclination angle of the display panel can be up to 75° to 90°, thereby ensuring the effective detection of defects.

As illustrated in FIG. 1 and FIG. 2, in one embodiment, the link mechanism 5 can comprise a first link 51, a second link 52 and a fastening device 53 for adjusting an included angle between the first link 51 and the second link 52. One end of the first link 51 is hinged with the upper handle arm 3 via the third pivot c, and the other end of the first link 51 is hinged with one end of the second link 52, the other end of which is hinged with the compressing block 21 of the lower handle arm 2 via the fourth pivot d. The fastening device 53 for adjusting the included angle between the first link 51 and the second link 52 can comprise: a first boss provided on the first link, a second boss provided on the second link, and a screw. The first boss is provided with a screw hole for the screw. The screw is engaged with the screw hole so as to be fit in the first boss. One end of the screw penetrates through the screw hole of the first boss and abuts on the second boss. The included angle between the first link and the second link can be changed by adjusting the movement of the screw with respect to the screw hole.

The distance between the two ends of the link mechanism 5 can vary by changing the included angle between the first link 51 and the second link 52. The resultant compression amount of the spring 23, i.e., the magnitude of the compression energizing force of the spring 23, can vary by changing the distance between the two ends of the link mechanism 5. Since the elastic force generated by release of the energizing force of the spring 23 acts on the display panel through the press head 41 eventually, the pressing force acting on the display panel by the press head 41 can be adjusted by changing the magnitude of the energizing force of the spring 23. That is to say, griping extent of the display panel gripped between the press head 41 and the base of the lighting-on machine can be adjusted.

As illustrated in FIG. 1 and FIG. 2, in a modified embodiment of the present disclosure, an engaging mechanism is disposed between the upper handle arm 3 and the lower handle arm 2. When the upper handle arm 3 rotates about the second pivot b so as to meet with the lower handle arm 2, the upper handle arm 3 and the lower handle arm 2 are connected in engagement by the engaging mechanism.

When the upper handle arm 3 rotates about the second pivot b so as to meet with the lower handle arm 2, the upper handle arm 3 and the lower handle arm 2 are connected in engagement so that the spring 23 is kept in an energized state. The spring 23 in an energized state can make the press head 41 keep pressing on the display panel. Therefore, it can be ensured that the display panel is kept inclined at 75° to 90° without a risk of slipping off the base.

As illustrated in FIG. 1 and FIG. 2, in a modified embodiment of the present disclosure, the press head 41 is provided with a pressing surface. The press head 41 can rotate about a rotating axis which is perpendicular to the pressing surface. In one embodiment, the press head 41 has a width less than 15 mm. The width of the press head 41 being less than 15 mm can ensure that the width is smaller than the width of the edge of the display panel. The press head 41 can rotate about the rotating axis e perpendicular to the pressing surface, which can ensure that the press head 41 performs the pressing action within the edge area of the display panel. Therefore, the grip device pressing the edge of the display panel will not affect the display area.

In one embodiment of the present disclosure, the press head 41 is a press head made of rubber material. Rubber material eliminates static electricity and thus will not affect the test of the display panel which is powered on. Further, since rubber material has certain elasticity, the press head 41 will not damage the pressed portion when pressing the display panel.

As illustrated in FIG. 1 and FIG. 2, in a modified embodiment of the present disclosure, the chassis 1 is provided with a sliding groove 11, and the lower handle arm 2 is provided with a slider 25 which can be slidably mounted in the sliding groove 11 along a direction in which the sliding groove 11 extends. The direction in which the sliding groove 11 extends is parallel with the first pivot a.

The grip device can be installed at an edge of the base of the lighting-on machine by the chassis 1. The lower handle arm 2 of the grip device can slide along the chassis 1 by means of the slider 25. Therefore, all the parts except the chassis 1 of the grip device can move along the edge of the base so that the grip device can grip various display panels having various dimensions.

As illustrated in FIG. 1 and FIG. 2, in a modified embodiment of the present disclosure, the slider 25 is mounted in the sliding groove 11, and the slider 25 can horizontally rotate by 180° about a rotating axis which is perpendicular to the sliding groove 11.

All the parts except the chassis 1 of the grip device can move along the edge of the display panel and can horizontally rotate by 180° with respect to the sliding groove 11 of the chassis 1. Therefore, the pressing portion of the press head 41 on the display panel can be easily adjusted. Moreover, both ends of the sliding groove 11 of the chassis 1 can be open so that the slider 25 can slide out of the openings at both ends of the sliding groove 11, which facilitates the installation and detachment of the grip device.

As illustrated in FIG. 1 and FIG. 2, in a modified embodiment of the present disclosure, the grip device further comprises a guiding rod positioned within the guiding groove 22. One end of the guiding rod is mounted to the second end of the lower handle arm 2. The spring 23 and the compressing block 21 are disposed around the guiding rod. The guiding rod can guide the compression of the spring 23 and the movement of the compressing block 21 along the guiding groove 22.

As illustrated in FIG. 1 and FIG. 2, based on the above embodiments, in one embodiment of the present disclosure, the grip device can further comprise a tension spring 24. One end of the tension spring 24 is connected with the guiding rod and the other end of the tension spring 24 is connected with the press rod 4. The connecting point between the tension spring 24 and the press rod 4 is positioned between the first pivot a and the second pivot b. In this grip device, one end of the press rod 4 is mounted to the lower handle arm 2. In non-operating state, the press rod 4 is subjected to the pulling action of the tension spring 24 connected therewith so that the press rod 4 located at the other end can keep a certain distance from the display panel under test.

A lighting-on device comprises a grip device according to any one of the above technical solutions.

When the above lighting-on device performs lighting-on test of the display panel, the display panel is placed on the base of the lighting-on machine and the grip device can be installed at an edge of the base of the lighting-on machine. The press head 41 can press a side of the display panel which is opposite to the base so that the display panel is positioned between the base and the press head 41 of the grip device and thus is gripped. Therefore, the lighting-on device as described above can grip the display panel by use of the grip device cooperating with the base of the lighting-on machine. Therefore, during the lighting-on test, the inclination angle of the display panel can be up to 75° to 90°, thereby ensuring the effective test of defects.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201520128665.0 filed on Mar. 5, 2015, the disclosure of which is hereby entirely incorporated by reference.

1. A grip device comprising a chassis, a lower handle arm, a compressing block, an upper handle arm, a press rod, and a link mechanism, wherein
one end of the press rod is mounted to a first end of the lower handle arm via a first pivot, and the other end of the press rod is provided with a press head;
one end of the upper handle arm is mounted to the press rod via a second pivot which is positioned between the press head and the first pivot;
the lower handle arm is mounted on the chassis and is provided with a guiding groove extending in a direction from a first end to a second end of the lower handle arm; the compressing block can be slidably mounted to the lower handle arm along a direction in which the guiding groove extends, a spring is disposed between the compressing block and the lower handle arm and applies a thrust force to the compressing block towards a first end of the lower handle arm upon being energized;
one end of the link mechanism is mounted to the upper handle arm via a third pivot, and the other end of the link mechanism is mounted to the compressing block via a fourth pivot, and the angle between the link mechanism and the lower handle arm which is at the side of the first end of the lower handle arm is an acute angle;
the first pivot, the second pivot, the third pivot, and the fourth pivot are parallel with each other, and the first pivot is perpendicular to the direction in which the guiding groove extends.

2. The grip device according to claim 1, wherein the link mechanism includes a first link, a second link and a fastening device for adjusting an included angle between the first link and the second link, and one end of the first link is hinged with the upper handle arm, and the other end of the first link is hinged with one end of the second link, the other end of which is hinged with the compressing block in the lower handle arm.

3. The grip device according to claim 1, wherein an engaging mechanism is disposed between the upper handle arm and the lower handle arm, and the upper handle arm and the lower handle arm are connected in engagement by the engaging mechanism where the upper handle arm rotates about the second pivot so as to meet with the lower handle arm.

4. The grip device according to claim 2, wherein an engaging mechanism is disposed between the upper handle arm and the lower handle arm, and the upper handle arm and the lower handle arm are connected in engagement by the engaging mechanism where the upper handle arm rotates about the second pivot so as to meet with the lower handle arm.

5. The grip device according to claim 1, wherein the press head is provided with a pressing surface, and the press head rotates about a rotating axis which is perpendicular to the pressing surface.

6. The grip device according to claim 2, wherein the press head is provided with a pressing surface, and the press head rotates about a rotating axis which is perpendicular to the pressing surface.

7. The grip device according to claim 3, wherein the press head is provided with a pressing surface, and the press head rotates about a rotating axis which is perpendicular to the pressing surface.

8. The grip device according to claim 4, wherein the press head is provided with a pressing surface, and the press head rotates about a rotating axis which is perpendicular to the pressing surface.

9. The grip device according to claim 1, wherein the press head is made of rubber material.

10. The grip device according to claim 2, wherein the press head is made of rubber material.

11. The grip device according to claim 3, wherein the press head is made of rubber material.

12. The grip device according to claim 1, wherein the press head has a width less than 15 mm.

13. The grip device according to claim 2, wherein the press head has a width less than 15 mm.

14. The grip device according to claim 1, wherein the chassis is provided with a sliding groove, and the lower handle arm is provided with a slider which can be slidably mounted in the sliding groove along a direction in which the sliding groove extends, and the direction in which the sliding groove extends is parallel with the first pivot.

15. The grip device according to claim 2, wherein the chassis is provided with a sliding groove, and the lower handle arm is provided with a slider which can be slidably mounted in the sliding groove along a direction in which the sliding groove extends, and the direction in which the sliding groove extends is parallel with the first pivot.

16. The grip device according to claim 14, wherein the slider is rotatably mounted in the sliding groove by rotating by 180° about a rotating axis which is perpendicular to a bottom surface of the sliding groove.

17. The grip device according to claim 1, further comprising a guiding rod positioned within the guiding groove, one end of the guiding rod is mounted to the second end of the lower handle arm, and the spring and the compressing block are disposed around the guiding rod.

18. The grip device according to claim 2, further comprising a guiding rod positioned within the guiding groove, one end of the guiding rod is mounted to the second end of the lower handle arm, and the spring and the compressing block are disposed around the guiding rod.

19. The grip device according to claim 17, further comprising a tension spring, one end of which is connected with the guiding rod and the other end of which is connected with the press rod, and the connecting point between the tension spring and the press rod is positioned between the first pivot and the second pivot.

20. A lighting-on device comprising the grip device according to claim 1.
